(19) United States
(12) Patent Application Publication
(10) Pub. No.: US 2021/0335019 A1
(43) Pub. Date: Oct. 28, 2021

(54) METHOD AND DEVICE FOR PROCESSING THREE-DIMENSIONAL DATA POINT SET

(71) Applicant: SZ DJI TECHNOLOGY CO., LTD., Shenzhen (CN)

(72) Inventors: Pu LI, Shenzhen (CN); Xiaozhen ZHENG, Shenzhen (CN); Fu ZHANG, Shenzhen (CN)

(21) Appl. No.: 17/371,819

(22) Filed: Jul. 9, 2021

Related U.S. Application Data
(63) Continuation of application No. PCT/CN2019/071240, filed on Jan. 10, 2019.

(51) Int. Cl. G06T 9/40

(52) U.S. Cl. CPC G06T 9/40

(57) ABSTRACT

The present disclosure provides a three-dimensional (3D) data point set processing method, the 3D data point set being divided by a multi-tree method. The 3D) data point set processing method includes encoding or decoding a Nth layer of the multi-tree in by using a breadth-first approach; and encoding or decoding a first node by using a depth-first approach when all 3D data points in the first node of the Nth layer fall into a same node of a Mth layer under the first node, wherein N and M are integers greater than or equal to one.

### CROSS-REFERENCE TO RELATED APPLICATIONS

This application is a continuation of International Application No. PCT/CN2019/071240, filed on Jan. 10, 2019, the entire content of which is incorporated herein by reference.

### TECHNICAL FIELD

The present disclosure relates to the technical field of information processing and, more specifically, to a method and device for processing a three-dimensional (3D) data point set.

### BACKGROUND

A 3D data point set is a form of expression of a 3D object or scene, which is composed of a set of discrete points that are randomly distributed in space and express the spatial structure and surface properties of the 3D object or scene. The data of a 3D data point set may include 3D coordinates describing coordinate information, and further include attributes of the position coordinates. To accurately reflect the information in the space, the number of discrete points required is huge. Therefore, in order to reduce the bandwidth occupied by the data storage and transmission of the 3D data point set, the 3D data point set needs to be encoded and compressed, and there is a need to improve the encoding performance of encoding the 3D data point set.

### SUMMARY

One aspect of the present disclosure provides a three-dimensional (3D) data point set processing method, the 3D data point set being divided by a multi-tree method. The 3D) data point set processing method includes encoding or decoding a Nth layer of the multi-tree in by using a breadth-first approach; and encoding or decoding a first node by using a depth-first approach when all 3D data points in the first node of the Nth layer fall into a same node of a Mth layer under the first node, wherein N and M are integers greater than or equal to one.

Another aspect of the present disclosure provides a device for processing a 3D data point set, the 3D data point set being divided in a multi-tree method. The device includes a first encoding or decoding unit configured to encode or decode a Nth layer of the multi-tree by using a breadth-first approach; and a second encoding or decoding unit configured to encode or decode a first node by using a depth-first approach when all 3D data points in the first node of the Nth layer fall into a same node of a Mth layer under the first node, wherein N and M are integers greater than or equal to one.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a block diagram of a method for encoding a 3D data point set according to an embodiment of the present disclosure.

FIG. 2 is a block diagram of a method for decoding the 3D data point set according to an embodiment of the present disclosure.

FIG. 3 is a schematic diagram of cubic octree division according to an embodiment of the present disclosure.

FIG. 4 is a schematic diagram of an octree coding scheme according to an embodiment of the present disclosure.

FIG. 5 is a flowchart of a method for processing a 3D data point set according to an embodiment of the present disclosure.

FIG. 6 is a schematic diagram of a node index according to an embodiment of the present disclosure.

FIG. 7 is a schematic diagram of another node index according to an embodiment of the present disclosure.

FIG. 8 is a schematic diagram of another octree coding scheme according to an embodiment of the present disclosure.

FIG. 9 is a schematic diagram of another octree coding scheme according to an embodiment of the present disclosure.

FIG. 10 is a block diagram of another method for encoding the 3D data point set according to an embodiment of the present disclosure.

FIG. 11 is a block diagram of another method for decoding the 3D data point set according to an embodiment of the present disclosure.

FIG. 12 is a schematic diagram of a hierarchical structure of a level of detail (LOD) coding scheme.

FIG. 13 is a block diagram of another method for encoding the 3D data point set. according to an embodiment of the present disclosure.

FIG. 14 is a block diagram of another method for decoding the 3D data point set according to an embodiment of the present disclosure.

FIG. 15 is a block diagram of another method for decoding the 3D data point set according to an embodiment of the present disclosure.

FIG. 16 is a block diagram of another method for decoding the 3D data point set according to an embodiment of the present disclosure.

FIG. 17 is a schematic diagram of a distance measuring device according to an embodiment of the present disclosure.

FIG. 18 is a schematic diagram of the distance measuring device according to an embodiment of the present disclosure.

FIG. 19 is a schematic diagram of a scanning pattern according to an embodiment of the present disclosure.

FIG. 20 is a schematic diagram of a device for processing the 3D data point set according to an embodiment of the present disclosure.

FIG. 21 is a schematic diagram of a computer system according to an embodiment of the present disclosure.

### DETAILED DESCRIPTION OF THE EMBODIMENTS

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

Unless otherwise defined, all the technical and scientific terms used in the present disclosure have the same or similar meanings as generally understood by one of ordinary skill in the art. As described in the present disclosure, the terms used in the specification of the present disclosure are intended to describe example embodiments, instead of limiting the present disclosure.

The 3D data point set can be composed of discrete 3D data points. The data of each 3D data pint may include information describing the position coordinates of the 3D data point, and may further include attribute information. In some embodiments, the position coordinates of the 3D data points can be 3D position coordinates (x, y, z). The attribute of the 3D data points can include reflectance and/or color of the 3D data points.

The 3D data point set described in the embodiments of the present disclosure may be a point cloud, and correspondingly, the 3D data point may be a point cloud point. The 3D data point set described in the embodiments of the present disclosure can be used for high-precision 3D maps.

The 3D data point set in the embodiments of the present disclosure may be obtained by optical detection (e.g., laser detection) of an object to be detected by an optical detection device. The optical detection device may be a photoelectric radar or a lidar. The encoder in the embodiments of the present disclosure can be integrated into the optical detection device.

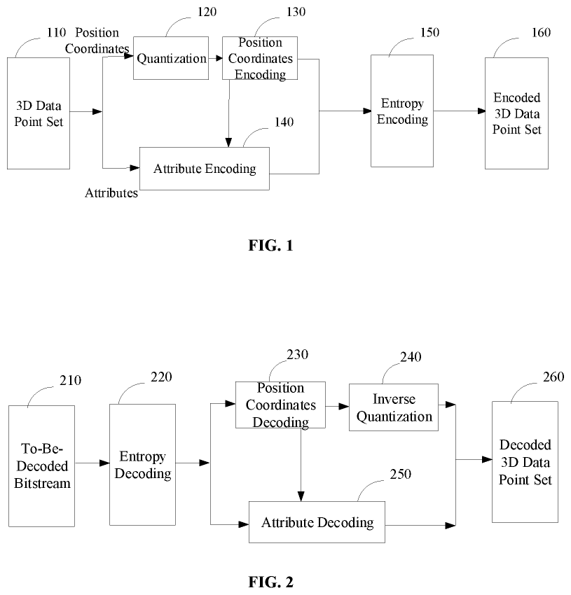

In order to accurately reflect spatial information, the number of 3D data points included in the 3D data point set is generally relatively large. To reduce the bandwidth occupied by the 3D data point set storage and transmission, the 3D data point set needs to be encoded and compressed. The encoding and decoding of a 3D data point set will be described below in conjunction with FIG. 1 and FIG. 2.

In the encoding method shown in FIG. 1, in the process at 110, the data of the 3D data point set is input into an encoder, and in the process at 120, the position coordinates in the data of the 3D data point set are quantified. For example, the position coordinates of each 3D data point can be quantified based on the difference between the maximum and minimum values of the position coordinates on the three axes, and the quantization accuracy determined based on the input parameter, and the position coordinates of the input 3D data point can be converted to integer coordinates greater than or equal to zero. In the process at 130, the quantized position coordinates are encoded. In the process at 140, the attributes in the data of the 3D data point set are encoded in the order of the position coordinates after the position coordinate encoding. In the process at 150, entropy encoding is performed on a code stream obtained after encoding the position coordinates and a code stream obtained after attribute encoding. In the process at 160, the data of the encoded 3D data point set can be output, for example, it can be output to a memory for storage, or it can be transmitted to decoding end.

In the decoding method shown in FIG. 2, in the process at 210, the code stream to be decoded of the 3D data point set is obtained. For example, the code stream can be obtained from the memory, or the code stream transmitted by the encoding end can be obtained. In the process at 220, entropy decoding is performed on the code stream, and the code stream corresponding to the position coordinates and the code stream corresponding to the attribute can be obtained. In the process at 230, position coordinates decoding is performed on the code stream corresponding to the position coordinates. In the process at 240, inverse quantization is performed on the decoded position coordinates. In the process at 250, the attributes are decoded in the order of the decoded position coordinates. In the process at 260, the decoded 3D data point set is obtained based on the decoded attributes and position coordinates.

It should be understood that the data of the 3D data points described above may include attribute information. However, it should be understood that in the embodiments of the present disclosure, the data of the 3D data points may not include the attribute information, but only the position coordinate information.

When encoding or decoding the position coordinates of the 3D data points, a multi-tree method can be used for encoding or decoding. In some embodiments, the multi-tree mentioned in the embodiments of the present disclosure may be an octree, a quadtree, a binary tree, or a mixture of two types of multi-tree, or a mixture of three types of multi-tree.

In some embodiments, when performing multi-tree encoding, the corresponding node can be divided into a multi-tree at each layer, and bits can be used to reflect the division of the node's multi-tree. Specifically, the nodes can be divided to obtain the presence of data in each sub-node.

Correspondingly, when performing multi-tree decoding, the corresponding bits can be obtained at each layer, and the corresponding nodes can be divided into the multi-tree based on the obtained bits.

For the encoding end, when the multi-tree division is performed, the division of each layer of the multi-tree can use the coordinates of the center point of the current node to divide the sub-nodes. The current node can be divided into multiple sub-nodes through the center point, and whether there are 3D data points in each sub-node can be determined, and the sub-nodes with the 3D data points can be further divided until the sub-nodes are divided to a preset size. For example, the division can be stopped when dividing to a sub-node with a side length of one.

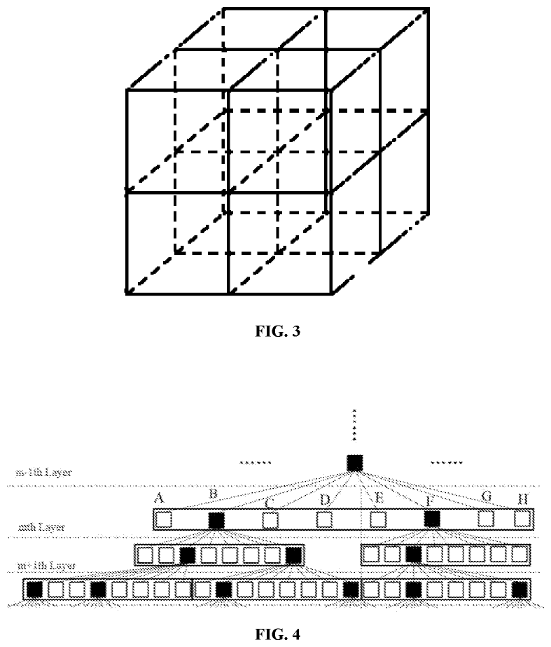

For example, take the octree division as an example. As shown in FIG. 3, a node is divided into 8 sub-nodes, and FIG. 4 is a schematic diagram of dividing nodes layer by layer.

In some embodiments, when performing multi-tree encoding or decoding, a breadth-first approach can be used for encoding.

For example, when compressing and encoding the position coordinates of 3D data points, the octree can be encoded layer by layer based on the breadth-first traversal sequence of the octree, and the division of each octree can be encoded layer by layer. Further, whether the eight sub-nodes obtained by dividing each node into an octree include 3D data points can be determined. If the eight sub-nodes include the 3D data points, the division can be continued until the sub-nodes are divided to a preset size.

In conjunction with FIG. 4, the following description takes an octree encoding as an example to explain the breadth-first encoding method.

Take FIG. 4 as an example. The black squares in FIG. 4 indicate the current sub-node includes 3D data points, and the white squares indicate that the current sub-node does not include 3D data points. When dividing the root node into an octree, whether each sub-node includes 3D data points can be determined. Take the first layer in FIG. 4 as an example, the third node in the octree divided for the first time includes 3D data points, and the remaining seven nodes do not include the 3D data points. The division can be represented by 8 bits, such as 0010 0000. Then the sub-node including data points can be divided, that is, the second layer of division in FIG. 4. In the second layer, the third node and the eighth node include 3D data points, and the octree division can be represented by 0010 0001. Subsequently, the two sub-nodes with 3D data points can be divided in sequence. In some embodiments, the division can be performed based on in the order of breadth-first. In the third layer, the left sub-node is first divided, and the result of the division is shown in the left half of the third layer in FIG. 4. The first sub-node and the fourth sub-node include 3D data points, and the octree division can be represented by 1001 0000. Then the second sub-node with 3D data points in the second layer cab be divided. The division result is shown in the right half of the third layer in FIG. 4. The second and eighth sub-nodes include 3D data points, and the octree division can be represented by 0100 0001. The division of subsequent layers is similar to the previous description, which is divided layer by layer in the breadth-first traversal order.

The binary code stream corresponding to the division result in FIG. 4 is 0010 0000 0010 0001 1001 0000 0100 0001 . . . . When the division reaches the last layer, that is, the side length of the sub-node is one, the deepest position of the octree division has been reached at this point, that is, the leaf node of the current octree has been reached, and no further division may be needed. Next, the number of 3D data points included in the current leaf node may need to be encoded. When the current leaf node includes a 3D data point, a 0 may be directly encoded to represent the 3D data point. When the current leaf node includes more than one 3D data point, the current leaf node can be set to include n 3D data points. In this case, a 1 can be encoded first, and then a value (n−1) can be encoded.

In some embodiments, the binary bit stream previously encoded to represent the octree division can be sent bit by bit to an arithmetic encoding engine for arithmetic encoding, and then the binary bit stream representing the number of 3D data points in the leaf node can be sent to the arithmetic encoding engine for arithmetic encoding. Based on the above process, the encoding of the position coordinates in the point cloud data can be realized.

With the development of encoding technology, the requirements for the encoding performance of the 3D data point set are getting higher and higher, and there is a need to improve the performance of multi-tree encoding.

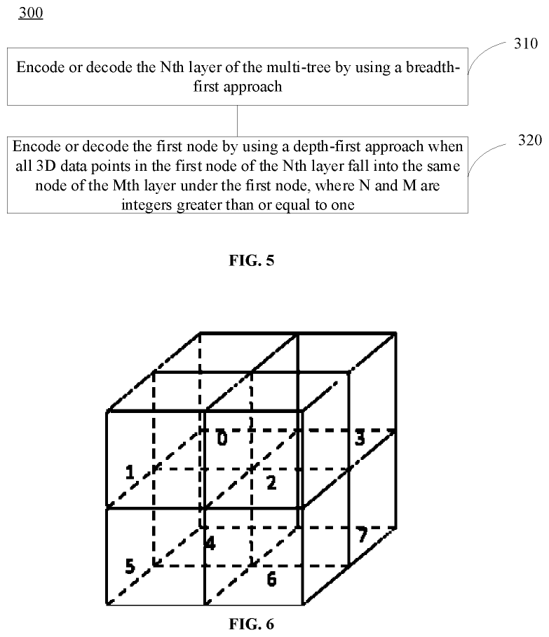

FIG. 5 is a schematic diagram of processing a 3D data point set according to an embodiment of the present disclosure. In some embodiments, the 3D data point set can be encoded or decoded in a multi-tree manner. This method can be implemented by the encoding end or the decoding end. The method may include at least part of the following processes.

In the process at 310, the Nth layer of the multi-tree is encoded or decoded by using the breadth-first approach.

In the process at 320, in the case where all 3D data points in the first node of the Nth layer fall within the same node of the Mth layer under the first node, the first node can be encoded or decoded in a depth-first manner, where N may be greater than or equal to 0, and M may be an integer greater than or equal to 1. In some embodiments, the N and M count starting points (both counting from the root node) in the Mth layer and the Nth layer may be the same, that is, the counting may be performed at the same layer. At this time, it may indicate that the value of M is greater than N. In some embodiments, the division depth of the octree may be equal to or greater than M. In other embodiments, the Mth layer may be a leaf node.

Alternatively, in some embodiments, the Mth layer described above may also be understood as counting from the Nth layer as the zero counting starting point. For example, the Nth layer may be the second layer, and the Mth layer may be the first layer below the first node, that is, the third layer of the octree. In other embodiments, the depth of the octree may be equal to N+M (the Mth layer may be a leaf node), or it may be greater than N+M.

In some embodiments, the root node may be the 0th layer of the octree.

It should be understood that in the embodiments of the present disclosure, “in the case where all 3D data points in the first node of the Nth layer fall within the same node of the Mth layer under the first node” described in the process at 320 may indicate that all 3D data points in the first node fall into the same node in the Mth layer. The execution body of this method may perform the process of determining whether all 3D data points in the first node in the Nth layer fall into the same node of the Mth layer under the first node, or the execution body may not perform the process of determining whether all 3D data points in the first node in the Nth layer fall into the same node of the Mth layer under the first node.

For example, the encoding end may perform the process of determining whether all 3D data points in the first node in the Nth layer fall into the same node of the Mth layer under the first node, and the decoding end may not perform the process of determining whether all 3D data points in the first node in the Nth layer fall into the same node of the Mth layer under the first node.

It should be understood that the foregoing description mentioned that the breadth-first approach can be used for encoding or decoding at the Nth layer, but the embodiments of the present disclosure are not limited thereto. In the encoding or decoding process of the 3D data point set, the depth-first approach can also be used for encoding he first layer. For example, in the first layer, all 3D data points may fall into one of the divided nodes. At this time, the 3D data points may be encoded in a depth-first approach.

In some embodiments, encoding or decoding the first node in the depth-first manner may be understood that the first node can be encoded or decoded by switching the breadth-first approach to the depth-first approach. If the depth-first approach is used for encoding or decoding at the first layer, then encoding and decoding the first node by switching the breadth-first approach to the depth-first approach may be understood that the default of the system is to initially use the breadth-first approach for encoding or decoding, but when certain conditions are met, the encoding or decoding has switched to the depth-first approach.

It should also be understood that in the embodiments of the present disclosure, the execution of a certain process when certain conditions are met may not mean that as long as certain conditions are met, certain process must be executed, it may mean that certain conditions need to be met before executing certain process, and it may also be necessary to determine whether other conditions need to be met.

In some embodiments, the node in the embodiments of the present disclosure may be referred to as a block, and the sub-node may be referred to as a sub-block. Nodes (or blocks) and sub-nodes (or sub-blocks) in the embodiments of the present disclosure are relative concepts. For example, for the Nth layer, a node of this layer may be a sub-node of the upper layer (or higher layers), and may be a parent node of the next layer.

In some embodiments, encoding or decoding in the breadth-first approach at a certain layer may refer to encoding or decoding multiple nodes within a specified range of the layer, and then encoding the nodes of the next layer. The multiple nodes in the specified range may refer to all nodes of one layer in the multi-tree encoding process, or sub-nodes of the nodes of one or more layers above, or nodes other than the nodes or their sub-nodes that are encoded or decoded in the depth-first approach.

In some embodiments, encoding or decoding a node in the depth-first approach may indicate that the node is not interspersed with the bits of other nodes in the coding bits (which may be bits reflecting the division of the multi-tree, and may further include a bit describing the number of point cloud points included in the leaf node) of the current layer and the lower layer of the current layer. That is, the bits of the node and its sub-nodes may be continuous and clustered together.

It should be understood that the term breadth-first or depth-first mentioned in the foregoing embodiments may also have other names, such as breadth or depth.

In some embodiments, the nodes of a certain layer may be understood as the nodes in the layer that have not been divided by the multi-tree division. The multi-tree division of a layer may be understood as the division of multiple sub-nodes of the nodes with 3D data points in the layer.

In some embodiments, the Mth layer mentioned above may be one layer different from the Nth layer, or it can be different by multiple layers. That is, all 3D data points in the first node of the Nth layer fall into the same node of the Mth layer under the first node, which can be understood as determining that the 3D data points of a node in the current layer fall into a node in each of the multiple layers below the Nth layer.

In some embodiments, since the 3D data points of a node may fall into the same sub-node of a certain layer below it, when encoding the node at that layer, only the index value of the sub-node may need to be encoded. In some embodiments, the index value may start from zero and accumulate based on one. For example, the index for each node of the octree may be 000, 001, 010, 011, 100, 101, 110, and 111.

More specifically, the bit value corresponding to the 3D data point of the first node in the Kth layer may include the index value of the node to which the 3D data point of the first node belongs in the Kth layer. In some embodiments, the Kth layer may be one of the layers under the first node, and in the Kth layer, all 3D data points in the first node may fall into one node.

Take octree coding as an example, the 3D data point of a node may fall into the first sub-node of the eight nodes of a certain layer, then the coding bit for this layer may be 000 at this time. That is, the bit describing the octree division of the node may be 000.

It should be understood that the value of K may be greater than or equal to M. That is, for the encoding end, depth-first encoding may be performed on the first node when it is determined that each of the two layers below a certain node and the 3D data points of the node fall into the same node. In some embodiments, in each of the three layers below the node, when the 3D data points of the node all fall into the same node, when encoding each of the three layers, the index value of the node to which the 3D data point belongs can be encoded.

In some embodiments, the index value of each node in the Kth layer may be preset.

More specifically, the index value of each node in the Kth layer may be preset based on the position of each node. That is, the index value of each node can be fixed.

For example, as shown in FIG. 6, regardless which layer of the octree is divided, the index value of the block at the same position is fixed. For example, the index value of the block after the upper left is 0 (converted to binary is 000), and the index value of the block after the lower right is 7 (converted to binary is 111).

It should be understood that the index values of the nodes show in FIG. 6 are a specific implementation of the present disclosure, and should not be understood as a limitation to the embodiments of the present disclosure, and the embodiments of the present disclosure may also have other implementations. For example, any number from 0 to 7 may be encoded for any one of the eight blocks, but the index value from 0 to 7 may only be used by a block in one position in one encoding scheme, and may not be reused.

Alternatively, in the embodiments of the present disclosure, the starting index value of the multiple index values corresponding to the multiple nodes in the Kth layer may be determined based on the node to which at least one 3D data point belongs in the upper layer of the Kth layer.

More specifically, the index value of the node at the corresponding position in the Kth layer where the position of the node of the previous layer is located may be the starting index value.

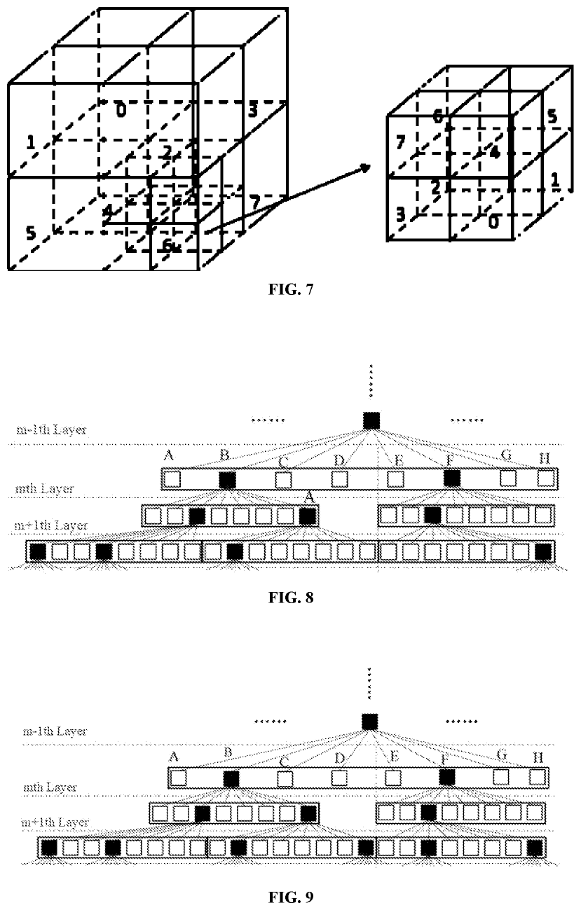

For example, when assigning index values to blocks, a fixed allocation scheme can be used for the division of sub-blocks of the depth-first octree. For details of the allocation scheme, reference can be made to the scheme described in FIG. 6 above. When the octree is divided into sub-blocks of the subsequent layer, the position of the sub-block with 3D data point in the previous layer can be used as the position of index zero in sub-blocks of the new octree. For example, as shown in FIG. 7, in the upper layer, the block before the lower right is a block with 3D data points in the previous block. Then the block is further divided to obtain the cube on the right side of FIG. 7, and the index value of each block can be determined by using the index value of the block before the lower right as zero.

In some embodiments, it is possible that the first node may only be in the lower part of the layer, and the 3D data points in the first node may fall into a sub-node, while in other lower layers, the 3D data points in the first node may fall into multiple sub-nodes. In this case, in other lower layers, it may be difficult to encode the index values because if the index values are encoded, the decoding end may not be able to perform decoding. in the embodiments of the present disclosure, the sub-nodes of the first node can be encoded or decoded in a breadth-first approach at the other lower layers.

More specifically, when all the 3D data points of the first node fall into the multiple sub-nodes of the first node in the Qth layer, in the Qth layer, the multiple sub-nodes of the first node can be encoded in a breadth-first manner, where Q may be an integer greater than or equal to one, and the Qth layer may be a layer below the Mth layer.

In some embodiments, a first identifier may be set before the coding bit corresponding to the Qth layer, and the first identifier may indicate that a breadth-first approach is adopted in the Qth layer to encode the sub-nodes of the first node.

More specifically, since the first node is encoded or decoded in a depth-first manner starting from the Nth layer, in at least some subsequent layers, since the 3D data points of the first node fall into multiple sub-nodes, encoding cannot be performed by using the index values. At this time, the first identifier may be added before the bit corresponding to the first layer or all layers of the at least some layers (the bit may be a bit of the sub-node of the first node), indicating that the current layer (which may further include subsequent layers) can adopt the breadth-first approach to encode or decode the sub-nodes of the first node. In this way, when the first identifier is obtained at the decoding end, the current layer (which may further include subsequent layers) can be used to decode the sub-nodes of the first node in a breadth-first manner.

In some embodiments, when the Qth layer is the first layer in the layers below the Nth layer that encodes the sub-nodes of the first node in a breadth-first manner, the first identifier may be set before the coding bit corresponding to the Qth layer (specifically, a bit describing the division of the first node in the Qth layer of the octree).

That is, other than the Nth layer, if there are multiple layers that use the breadth-first approach to encode or decode the sub-nodes of the first node, then the first identifier may only be set before the coding bit corresponding to the first layer that encodes the sub-nodes of the first node in the breadth-first manner.

In some embodiments, the number of bits of the first identifier may be equal to the number of bits of the index value of each node. For example, for an octree, the index value of a node may have four bits, and the first identifier may also have four bits. The bit value of the first identifier may not be equal to the bit value of any index value, and the bit value of the index value of each node may be different.

Alternatively, in some embodiments, the bit value of the first identifier may be equal to the bit value of the index value of one node in each node. There may be a first identification bit after the first identifier, and the first identification bit may be used to indicate that the value of the previous bit indicates the first identifier. A second identification bit may be after the index value of the node, and the second identification bit may be used to indicate that the value of the previous bit indicates the index value of the node. The number of bits of the first identification bit may be equal to the number of bits of the second identification bit, but the values of the bits may be different.

For example, for octree encoding, the index value of the node may be from 000 to 111, and the bit value of the first identifier may be 111. To distinguish whether 111 is the index value or the first identifier, an identification bit can be added after 111. If the value of the identification bit is 1, then 111 may be the index value; and if the value of the identification bit is 0, then 111 may be the first identifier.

The above description takes the first identification bit after the first identifier not belonging to the first identifier, and the second identification bit after the index value of a node not belonging to the index value as an example. The embodiments of the present disclosure may also be understood differently.

For example, the first identifier may include a prefix and a suffix, and the index value of a node may include a prefix and a suffix. The bit value of the prefix of the first identifier may be equal to the bit value of the prefix of the index value of the node. The number of bits in the suffix of the first identifier may be equal to the number of bits in the suffix of the index value of the node, and the bit value of the suffix of the first identifier may not be equal to the bit value of the suffix of the index value of the node. The number of bits of the prefix of the index value of the node may be equal to the number of bits of the index value of other nodes, and the bit value of the prefix of the index value of the node may be different from the index values of other nodes.

For example, for octree encoding, the index value of the node may include the index value from 000 to 110 and 1111, and the bit value of the first identifier may be 1110. In some embodiments, the first three is in the index value 1111 may be prefixes, and the last 1 may be the suffix; and, the first three 1s in the first identifier 1110 may be prefixes, and the last 0 may be the suffix.

Therefore, when decoding the prefix, the decoding end can determine whether the decoded value is the index value or the first identifier based on the suffix.

In one example, there may be only one 3D data point in the first node. In some embodiments, when the first node includes one 3D data point, all layers below the first node may not be converted to the breadth-first manner to encode or decode the sub-nodes of the first node.

In one example, when there is only one 3D data point in the first node of the Nth layer, the first node may be encoded or decoded in a depth-first manner. In addition, when the first node is encoded or decoded in the depth-first manner, there may be no need to switch from the depth-first approach to the breadth-first approach for encoding or decoding. In one example, when there is only one 3D data point in the first node of the Nth layer, and the side length of the first node is greater than a threshold, the first node may be encoded or decoded in the depth-first manner.

In some embodiments, the bit value of the 3D data point of the first node corresponding to the Kth layer may include an index value, and the index value may be a preset fixed value.

In some embodiments, the index value may be 111.

In some embodiments, in the case that the first node includes one 3D data point, the number of bits in the index value of each node may be the same, that is, each node may not include an index value of a node including prefix and suffix. Alternatively, it can be understood that there may be no need to add an identification bit after the index value of a node. This is because when the first node includes one 3D data point, there may be no need to switch from the depth-first approach to the breadth-first approach, and the first identifier mentioned above may not need to be added to the bit stream.

In some embodiments, when encoding or decoding the first node in the depth-first manner, before the bit used to describe the sub-node division of the first node, there may be a second identifier indicating the at the first node is encoded or decoded in a switch from breadth-first to depth-first.

More specifically, for the encoding end, the second identifier can be set before the bit used to describe the sub-node division of the first node. The second identifier may indicate that the first node is encoded or decoded in a switch from breadth-first to depth-first. Therefore, when the second identifier is obtained, the encoding end can determine to decode the first node using the depth-first approach.

In some embodiments, the second identifier may indicate that all 3D data points in the first node fall into the same node of the Mth layer under the first node. When the second identifier is obtained, the decoding end may decode the first node using the depth-first approach.

That is, the decoding end does not need to determine whether all the 3D data points in the first node fall into the same node of the Mth layer under the first node. The decoding end may only need to obtain the second identifier to encode or decode the first node in the depth-first manner.

In some embodiments, the number of bits of the second identifier may be the same as the number of nodes obtained when the multi-branch tree is divided. More specifically, the second identifier may be a plurality of zeros, and zero may indicate that the corresponding node does not include a 3D data point.

For example, for an octree, the second identifier may be 00000000. When the decoding end performs decoding, after obtaining 00000000, since there will be no result of 000000 identifying the octree division, 00000000 may be considered as the second identifier described above.

It should be understood that the second identifier may be composed of a plurality of ones. In this case, one may indicate that the corresponding node does not include a 3D data point.

In some embodiments, if there are multiple first nodes in the Nth layer, the second identifier may be set before the coding bit corresponding to each first node.

The above described the process of the first node performing encoding or decoding. When performing octree encoding, there may be a node in the Nth layer whose sub-nodes do not fall into a sub-node of the Mth layer. In this case, the node and its sub-nodes can be coded in the Nth layer and the layers below the Nth layer by using the breadth-first approach.

In some embodiments, whether each node of the layer meets the conditions described above (in the process at 320) can be determined at each layer. If the conditions are not met, then the corresponding current node can be encoded using the breadth-first approach in the current layer, otherwise, the depth-first approach can be used for encoding.

Alternatively, in some embodiments, the determination of whether each node of the layer meets the conditions described above (in the process at 320) can be performed at a part of the layers. For example, the determination can be performed at the fifth layer of the octree division.

In some embodiments, in the Nth layer and at least one layer below, the second node can be coded by using the breadth-first approach, where the second node may include at least one node among the nodes of the Nth layer and the layer below the Nth layer, except for the first node and its sub-nodes.

In some embodiments, when the breadth-first approach is used to encode the sub-nodes of the second node, the sub-nodes of the first node may be skipped. That is, the bits of the sub-nodes of the first node may not be set in the bitstream from the breadth-first encoding.

The first node mentioned in the embodiments of the present disclosure may be a node that meets the conditions described in the process at 320, and the second node may be a node that does not meet the conditions described in the process at 320. The conditions described in the process at 320 is that all 3D data points in the node fall into the same node of at least one layer below the node.

To understand the present disclosure more clearly, an octree will be used as an example to describe the positional relationship of the bits in the coded bitstream.

Assume that after the first-level octree division, there are 3D data points in a second sub-node A, a third sub-node B, and an eighth sub-node C, then the coded bit stream of the first layer may be 01100001.

After performing the second-level octree division, the third sub-node B may be identified as the first node (that is, the node that meets the conditions mentioned in the process at 320), and the two sub-nodes (the second sub-node A and the eighth sub-node C) may be nodes other than the first node. After the second sub-node A is divided, point cloud data may be in a first sub-node D and a second sub-node E; after the third sub-node B is divided, a seventh sub-node F may include point cloud data; and after the eighth sub-node C is divided, point cloud data may be in a third sub-node G and a fourth sub-node H. In this way, the coded bits after 01100001 may be 11000000 (which represents the octree division of the second sub-node A mentioned above) plus 00000000 (the second identifier) plus the depth-first coding bits for the third sub-node B described above (110 plus the coding bits of the layer below the third sub-node B mentioned above) plus 00110000 (which represents the octree division of the eighth sub-node C mentioned above).

In some embodiments, the coding bits of the layer below the third sub-node B may include bits describing the division of the octree from the third layer to the bottom layer, and bits describing the number of 3D data points in each leaf node in the bottom layer. The depth-first coding bits of the third sub-node B mentioned above will be described below. The depth-first coding bits may include 110, and then include the coding bits of the layer below the third sub-node B. Since the sub-nodes of the second sub-node B in the second layer is the seventh sub-node F, there may be 3D data points. If the seventh sub-node F is divided in the third layer, there may be point cloud points in a first sub-node I and a fifth sub-node K. In this way, for the depth-first coding bits of the second sub-node C, the coding bits after 110 may be 1111 (the first identifier plus the indication 111 is the identification bit of the first identifier) plus 10001000.

Subsequently, the third layer of breadth-first encoding can be performed. In some embodiments, in the encoding process, the sub-nodes of the third sub-node B as the first node may be skipped. That is, the coding bits after the bitstream (11000000 (which represents the octree division of the second sub-node A mentioned above) plus 00000000 (the second identifier) plus the depth-first coding bits for the third sub-node B described above (110 plus the coding bits of the layer below the third sub-node B mentioned above) plus 00110000 (which represents the octree division of the eighth sub-node C mentioned above)) may not include the bits of the sub-nodes of the third sub-node B as the first node.

In some embodiments, when there is multiple first nodes in the Nth layer, the encoding or decoding processing of any one of the first nodes and its sub-nodes may be parallel to the encoding or decoding processing of other first nodes and their sub-nodes.

More specifically, since the encoding and decoding processing of each first node may be independent of each other, the encoding or decoding processing of any one of the first nodes and its sub-nodes and the encoding and decoding processing of other first nodes and their sub-nodes may be performed in parallel, thereby improving the encoding and decoding efficiency.

Alternatively, the encoding or decoding processing of any one of the sub-nodes of the first node may be parallel to the encoding or decoding processing of other sub-nodes of the first node.

In some embodiments, the encoding and decoding processing of the first node and its sub-nodes may be parallel to the encoding and decoding processing of nodes other than the first node (such as the second node) and their sub-nodes in the Nth layer.

More specifically, since the encoding or decoding processing of the first node may be independent of the encoding or decoding processing of other nodes, then the encoding or decoding processing of the first node and its sub-nodes may be parallel to the encoding or decoding processing of the nodes and sub-nodes other than the first node in the Nth layer, thereby improving the encoding and decoding efficiency.

Alternatively, the encoding or decoding processing of the sub-nodes of the first node may be parallel to the encoding or decoding processing of the sub-nodes of nodes other than the first node in the Nth layer.

To understand the present disclosure more clearly, an embodiment of the present disclosure will be described below by taking FIG. 8 as an example. FIG. 8 shows that when there is only one 3D data point in the block, the block is encoded in a depth-first manner. This is because if the block includes only one 3D data point, then in its subsequent layers, the 3D data point will only fall into one sub-block, which can be encoded in the depth manner.

As shown in FIG. 8, in the m−1th layer octree division encoding, the breadth-first order is used for encoding. In one layer, the octree sub-blocks are divided in order and an 8-bit binary number is used to indicate the division of the current block, and each sub-block in turn corresponds to 1 bit of the bit binary number. If there are 3D data points in the sub-block, the corresponding 1-bit sub-block is represented by 1, and if there are no 3D data points in the sub-block, the corresponding 1-bit sub-block is represented by 0. Based on this coding method, the sub-blocks with 3D data points in the m−1th layer can be traversed to divide these sub-blocks into an octree, and the data distribution of the sub-blocks can be encoded based on the same method. All the octree division of the m−1th layer can be encoded, and then the mth layer of the octree division can be encoded. When encoding to the F block, assume that the F block includes only one 3D datapoint, at this time, the division of the F block can be converted to the priority order for encoding. At this time, in some embodiments, an identifier that switches from breadth-first to depth-first can be encoded in the bitstream (the identifier may be an 8-bit 00000000). Then octree division encoding can be performed on the sub-blocks of F block, and the encoding can be performed until the side length of the block is 1, that is, when the leaf node of the octree is reached, no further division is required. If there is only one 3D data point in the block at this time, the number of 3D data point in the block may not be encoded at this time. Then the encoding can be continued to the next sub-block of the mth layer in the breadth-first manner. When a sub-block including only one 3D data point is encountered in the next block, the encoding can be switched to the depth-first order again. When the encoding is completed, the mth layer will continue to encode the m+1 layer. It should be noted that when encoding to a sub-block of a depth-first block, such as encoding to the sub-blocks of F block, since the octree division of these sub-blocks, sub-blocks of sub-blocks, etc. have been coded before, these sub-blocks can be directly skipped, and the encoding will not be repeated. When there is only one 3D data point in a block at the m+1 layer or later layers, the encoding will be switched to the depth-first order. The encoding rule may be the same as the rules for encoding the F block described above. When the octree is divided and coded in the order of breadth-first until the side length of the sub-block is 1, the leaf node of the octree can be reached, and no further division may be required. Subsequently, the number of data points in the 3D data point set included in the current sub-block, that is, the leaf node, can be encoded directly. Based on this method, the octree encoding of position coordinates based on the breadth-first depth-first hybrid can be realized.

For the decoding end, the input bitstream to be decoded can be arithmetically decoded first. The bitstream related to the position information can be decoded. When the octree decoding is performed, the bit stream of the position coordinates can be decoded in sequence. When the bitstream is breadth-first, it can be decoded in the breadth-first order, and when the bitstream is depth-first, it can be decoded in the depth-first order. Through octree decoding and inverse quantization, the reconstructed position coordinates can be obtained. Correspondingly, based on the position coordinates order after the position decoding, and based on the attribute information related bitstream obtained by arithmetic decoding, attribute decoding can be performed to obtain the reconstructed attribute information. The decoding of the bitstream of the 3D data point set can be realized based on the process described above.

In some embodiments, when performing octree decoding, the bitstream of the position coordinates can be decoded, which can be decoded in the breadth-first order. When decoding to an identifier indicating the switch from breadth-first to depth-first (such as decoding to the 8-bits of 0, that is, 00000000), the depth-first approach can be used for decoding and reconstruction. Based on this order for decoding, the octree decoding of the position coordinates can be realized.

In addition to the embodiment described above, the present disclosure can also be implemented in different methods. For example, to determine whether a node is encoded in the depth-first manner, the number of point cloud points in the node can be determined. Based on the number of point cloud points in the node, whether depth-first encoding can be used can be determined. For example, if the number of point cloud points in the node is less than or equal to a certain threshold, the depth-first approach can be used for encoding, otherwise, the breadth-first can be used for encoding.

The following uses FIG. 9 as an example to describe other implementation methods of the present disclosure.

As shown in FIG. 9, in the m−1th layer octree division encoding, the breadth-first order is used for encoding. In one layer, the octree sub-blocks are divided in order and an 8-bit binary number is used to indicate the division of the current block, and each sub-block in turn corresponds to 1 bit of the 8-bit binary number. If there are 3D data points in the sub-block, the corresponding 1-bit sub-block is represented by 1, and if there are no 3D data points in the sub-block, the corresponding 1-bit sub-block is represented by 0. Based on this coding method, the sub-blocks with 3D data points in the m−1th layer can be traversed to divide these sub-blocks into an octree, and the data distribution of the sub-blocks can be encoded based on the same method. All the octree division of the m−1th layer can be encoded, and then the mth layer of the octree division can be encoded. When encoding to block B in FIG. 9, at this time, the encoding can be switched to the depth-first traversal order, such that the octree division of block B can be encoded first, the octree division of sub-blocks with 3D data point in the m+1th layer of block B can be encoded, then the m+2th layer of block B can be encoded. The encoding can be continued until the side length of the block is 1, the leaf node of the octree is reached, and no further division is required. Subsequently, the number of 3D data points included in the current leaf node block may need to be encoded. When the current leaf node block includes one 3D data point, a 0 can be directly encoded to represent it. When the current leaf node block includes more than one 3D data point, assume that the current leaf node block includes n 3D data points, at this time a 1 can be encoded first, and then the value (n−1) can be encoded. Then the process returns to the mth layer, divides the F block into octree sub-blocks, and encodes the octree division of the F block. If there are 3D data points in the sub-block, the corresponding 1-bit sub-block is represented by 1, and if there are no 3D data points in the sub-block, the corresponding 1-bit sub-block is represented by 0. At this time, the binary bitstream describing the octree division of the B block and the sub-blocks of the B block will be stored in a storage space between the bitstream describing the division of the B block octree and the binary bitstream describing the division of the F block octree. Based on this encoding method, when encoding the division of the B block and the sub-blocks of the B block, the bitstream information can be continuously stored, and there may be no need to rely on the coding information of other adjacent blocks in the current layer. For the sub-blocks of the F block, the depth-first octree division position coordinate coding method can be selected first, and the breadth-first octree position coordinate coding method can be adopted subsequently. When the depth-first octree position coordinate coding method is used for the F block, the coding process may be similar to the depth-first octree position coordinate coding method of the B block described above. When the breadth-first octree position coordinate coding method is used for the F block, the coding process may be similar to the coding process described above. The octree division of the F block of the mth layer can be encoded first, and then the octree division of the mth layer's subsequent blocks including 3D data points can be encoded. When the encoding of the blocks of the mth layer is completed, the blocks of the m+1 layer can be encoded. It should be noted that when encoding to a sub-block of a depth-first block, such as encoding to the sub-blocks of block B, since the octree division of these sub-blocks, sub-blocks of sub-blocks, etc. have been encoded before, these sub-blocks can be directly skipped, and the encoding will not be repeated. The sub-blocks of the F block in the octree division of the m+1th layer can be directly encoded. The encoding of the octree division of the subsequent blocks may be similar to the process described above.

For the decoding end, the input bitstream to be decoded can be arithmetically decoded first. The bitstream related to the position information can be decoded. When the octree decoding is performed, the bit stream of the position coordinates can be decoded in sequence. When the bitstream is breadth-first, it can be decoded in the breadth-first order, and when the bitstream is depth-first, it can be decoded in the depth-first order. Through octree decoding and inverse quantization, the reconstructed position coordinates can be obtained. Correspondingly, based on the position coordinates order after the position decoding, and based on the attribute information related bitstream obtained by arithmetic decoding, attribute decoding can be performed to obtain the reconstructed attribute information. The decoding of the 3D data point set can be realized based on the process described above.

Similarly, in the embodiment shown in FIG. 9, when the breadth-first approach is switched to the depth-first approach, an identifier, such as 00000000, can be added, and when the depth-first approach is switched from the breadth-first approach, an identifier, such as 1111, can also be added.

A parallel implementation method may also be used for the octree encoding process described above, which will be described in detail below. FIG. 9 is taken as an example to illustrate this parallel octree encoding method with a combination of the breadth-first approach and the depth-first approach. When encoding the m+1th layer of the octree division, the breadth-first approach can be used for encoding. The octree sub-blocks can be divided in order in one layer, and an 8-bit binary number can be used to indicate the division of the current block. Each sub-block may correspond to 1 bit of the 8-bit binary number in turn. If there is a point cloud data point in the sub-block, the 1 bit corresponding to the sub-block can be represented by 1; and if there is no point cloud data point in the sub-block, the 1 bit corresponding to the sub-block can be represented by 0. Based on this encoding method, the sub-blocks including the point cloud data points in the m−1th layer can be traversed to divide these sub-blocks into an octree, and encode the data distribution of the sub-blocks based on the same method. All the octree division of the m−1th layer can be encoded, and then the mth layer of the octree division can be encoded. When encoding to block B in FIG. 9, at this time, the encoding can be switched to the depth-first traversal order, such that the octree division of block B can be encoded first, the octree division of sub-blocks with the point cloud data in the m+1th layer of block B can be encoded, then the m+2th layer of block B can be encoded. The encoding can be continued until the side length of the block is 1, the leaf node of the octree is reached, and no further division is required. Subsequently, the number of point cloud data points included in the current leaf node block may need to be encoded. When the current lead node block includes a point cloud data point, a 0 can be directly encoded to represent it. When the current leaf node block includes more than one point cloud data point, assume that the current leaf node block includes n point cloud data points, at this time a 1 can be encoded first, and then the value (n−1) can be encoded. Then the process returns to the mth layer, divides the F block into octree sub-blocks, and encodes the octree division of the F block. If there is a point cloud data point in the sub-block, the corresponding 1-bit sub-block can be represented by 1, and if there are no point cloud data point in the sub-block, the corresponding 1-bit sub-block can be represented by 0. At this time, the binary bitstream describing the octree division of the B block and the sub-blocks of the B block will be stored in a storage space between the bitstream describing the division of the B block octree and the binary bitstream describing the division of the F block octree. Based on this encoding method, when encoding the division of the B block and the sub-blocks of the B block, the bitstream information can be continuously stored, and there may be no need to rely on the coding information of other adjacent blocks in the current layer. For the sub-blocks of the F block, the depth-first octree division position coordinate coding method can be selected first, and the breadth-first octree position coordinate coding method can be adopted subsequently. When the depth-first octree position coordinate coding method is used for the F block, the coding process may be similar to the depth-first octree position coordinate coding method of the B block described above. When the breadth-first octree position coordinate coding method is used for the F block, the coding process may be similar to the coding process described above. The octree division of the F block of the mth layer can be encoded first, and then the octree division of the mth layer's subsequent blocks including point cloud data points can be encoded. When the encoding of the blocks of the mth layer is completed, the blocks of the m+1 layer can be encoded. It should be noted that when encoding to a sub-block of a depth-first block, such as encoding to the sub-blocks of block B, since the octree division of these sub-blocks, sub-blocks of sub-blocks, etc. have been encoded before, these sub-blocks can be directly skipped, and the encoding will not be repeated. The sub-blocks of the F block in the octree division of the m+1th layer can be directly encoded. The encoding of the octree division of the subsequent blocks may be similar to the process described above. There is no dependency between the encoding results of the encoding B block and the sub-blocks of the B block previously described and the subsequent encoding F block. Therefore, for the sub-blocks that are converted from breadth-first to depth-first, a single process can be used for the octree encoding. After the encoding of the sub-block is completed, the encoded bitstream can be added to the corresponding position.

Correspondingly, for the decoding end, the input bitstream to be decoded can be arithmetically decoded first. The bitstream related to the position information can be decoded. When the octree decoding is performed, the bit stream of the position coordinates can be decoded in sequence. When the bitstream is breadth-first, it can be decoded in the breadth-first order, and when the bitstream is depth-first, it can be decoded in the depth-first order. Through octree decoding and inverse quantization, the reconstructed position coordinates can be obtained. Correspondingly, based on the position coordinates order after the position decoding, and based on the attribute information related bitstream obtained by arithmetic decoding, attribute decoding can be performed to obtain the reconstructed attribute information. The decoding of the bitstream of the 3D data point set can be realized based on the process described above.

Consistent with the present disclosure, for the octree encoding process of the point cloud position coordinates, a breadth-first depth-first hybrid octree encoding method can be used, which improves the flexibility and parallelism of the octree encoding process, and reduces the granularity in the octree encoding process. In addition, when the octree is divided into sub-blocks including only one point cloud data point, the sub-blocks can be directly encoded in the depth-first order, and three bits can be used directly to code the index value of the block with data. This method also improves the compression rate of the position coding to a certain extent. In order to indicate the priority type in the breadth-first depth-first hybrid structure, an 8-bit 0, that is, 00000000, can be used in the bitstream to indicate the switch from the breadth-first approach to the depth-first approach.

The above describes the process of performing multi-tree encoding on a set of 3D data points. The multi-tree encoding can be the position coordinates of the 3D data points. When the data of the 3D data points also include attribute information, the attribute information can be further encoded. The attribute encoding can be encoded using hierarchical encoding or binary encoding.

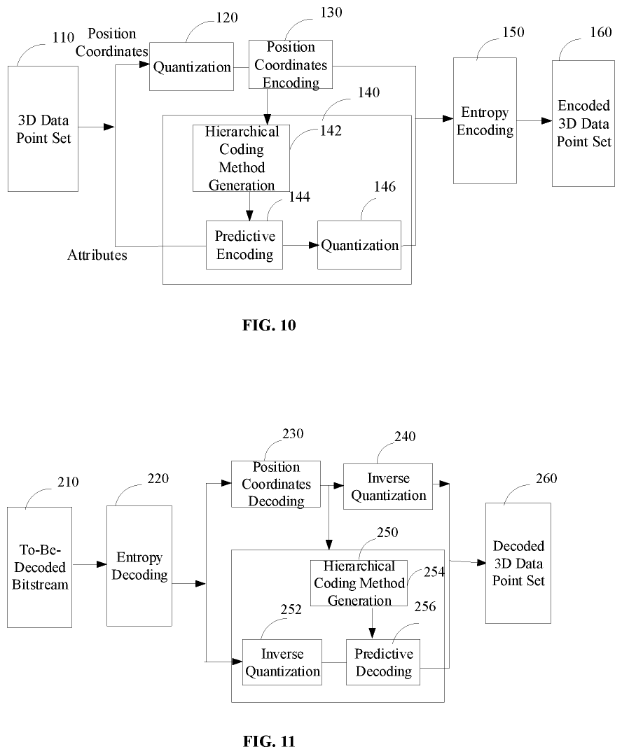

The following will describe the hierarchical encoding method in conjunction with FIG. 10 and FIG. 11. In particular, the symbols in FIG. 10 and FIG. 11 that are the same as those in FIG. 1 and FIG. 2 will not be described below. For detail, reference can be made to the descriptions of FIG. 1 and FIG. 2.

As shown in FIG. 10, in the process at 140, the encoding operations on attributes can include processes 142, 144, and 146. In the process at 142, based on the position coordinates encoded by the position coordinates, a level of detail (LOD) can be generated. In the process at 144, predictive encoding can be performed based on the hierarchical encoding method. In the process at 146, the result of the predictive encoding can be quantized.

As shown in FIG. 11, in the process at 250, the encoding operations on attributes can include processes 252, 254, and 256. In the process at 252, inverse quantization on the decoded attribute bitstream can be performed. In the process 254, a hierarchical decoding method based on the position coordinates after decoding the position coordinates can be generated. In the process at 256, predictive decoding can be performed based on the hierarchical coding method.

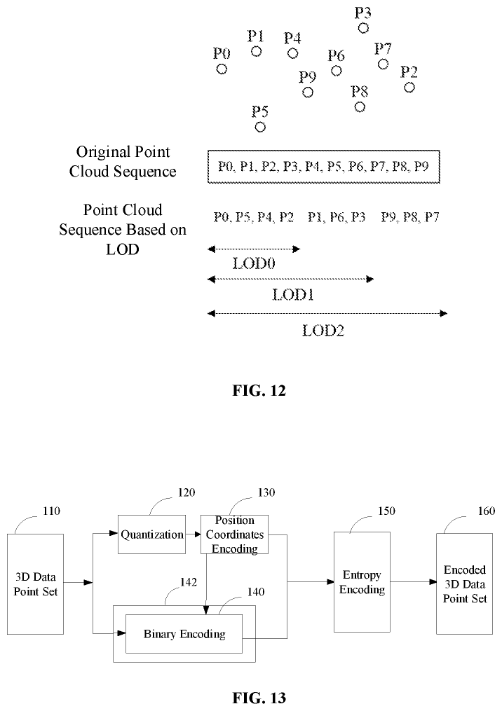

In the actual encoding process, LOD layering can be performed based on the parameters of the LOD configuration, where the latter layer may include the points of the previous layer. For example, as shown in FIG. 12, in LOD0 (layer 0), the 3D data points included are P0, P5, P4, and P2. In the LOD1 (layer 1), the 3D data points included are P0, P5, P4, P2, P1, P6, and P3. In the LOD2 (layer 2), the 3D data points included are P0, P5, P4, P2, P1, P6, P3, P9, P8, and P7.

In the layering process, a first 3D data point in the 3D data point set data can be first selected, and the first 3D data point can be placed at the first point of the LOD0 layer. Then the 3D data points can be sequentially traversed, and the distances in the Cartesian coordinate system between this point and all the points already included in the current layer can be calculated. If the minimum distance is greater than a distance threshold (dist2) set in the current LOD layer, this point will be categorized to the current LOD layer. In addition, in this process, the calculated distances can be sorted, and several shortest distances can be selected. This number can be determined by the number of neighbors during prediction (numberOfNeighborsInPrediction) N. In some embodiments, after a 3D data point is divided into a LOD layer, there may be no need to determine whether it belongs to the next LOD layer in the future. This is because the next layer includes the previous layer, therefore, the 3D data point must belong to the next LOD layer and a few points of the LOD0 layer. Since the number of points in the LOD may be relatively low, the number of selected reference points may be less than the number N.

After the LOD layer is divided, the nearest point previously selected can be used to assign weights for prediction. More specifically, for each 3D data point, after obtaining the nearest N points sorted by distance, the weight distribution method can be calculated based on one reference point, two reference points, and up to N reference points. There are N types of weigh distribution methods. When there is one reference point, the reference point may be the point with the shortest distance, and its weight may be one. When there are two reference points, the two points with the shortest distances can be selected as the reference points. At this time, the weight can be assigned based on the distance between the two reference points and the point to be predicted. The specific weight may be inversely proportional to the distance, the farther the distance, the smaller the weight, and the sum of the weight to be ensured to be one. When there are N reference points, N reference points can be selected, and the weight distribution method may be the same as above.

After assigning weights, the number of reference points can be selected. It should be noted that the number of adjacent reference points that can be selected for a prediction point may be less than or equal to N. More specifically, when the maximum number of reference points is limited to one, at this time the quantified value of the residuals between the predicted value (weight multiplied by the attribute value of the corresponding position) and the actual attribute value may be the sum of the values. This sum may be the cost when the number of reference point is at most one. Then the cost when the maximum number of reference point is limited to two can be traversed until the cost when the maximum number of reference points is limited to N, and a solution with the smallest cost and maximum number of reference points can be selected at the end. Subsequently, the quantized residual value can be encoded using this solution.

The header information about the attribute in the coded bitstream can describe the relevant information about the layered coding attribute, that is, the LOD. More specifically, when making prediction at each layer, the number of points (numberOfNeighborsInPrediction) adjacent to the reference point (the position coordinates used to calculate the residual), the number of LOD levels (levelOfDetailCount), the distance threshold for dividing each layer of the LOD (dist2), the quantization step size of each layer of the LOD (quantizationSteps), and the size of the dead zone of each layer of the LOD (quantizedDeadZoneSize) (that is, the residual interval to quantized the residual to 0) can be selected. In some embodiments, the last three attributes can be set for each layer of LOD, and the attributes of each layer can be written into the bitstream header information.

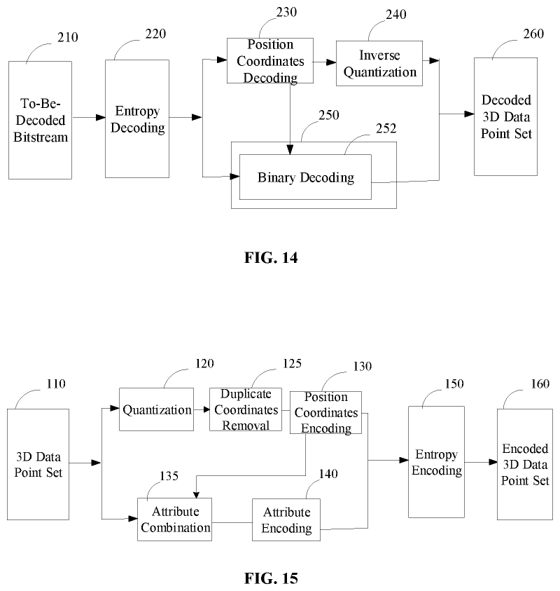

In some embodiments, as shown in FIG. 13, in the process at 142, the encoding of attributes can also be performed by binary encoding. As shown in FIG. 14, in the process at 252, the decoding of the attributes can also be performed in the manner of binarization decoding. In particular, the symbols in FIG. 12 and FIG. 13 that are the same as those in FIG. 1 and FIG. 2 will not be described below. For detail, reference can be made to the descriptions of FIG. 1 and FIG. 2.

In some embodiments, encoding using binary encoding can simplify the encoding method and reduce the time overhead of encoding and decoding, and there may be no need to add more encoding information to the bitstream, thereby increasing the compression rate.

The coding method of the binarization encoding in the embodiments of the present disclosure may be a fixed-length code coding method, a truncated Rice coding method, or a K-order exponential Golomb coding method. Correspondingly, the decoding method of the binarization decoding may be a fixed-length code decoding method, a truncated Rice decoding method, or a K-order exponential Golomb decoding method.

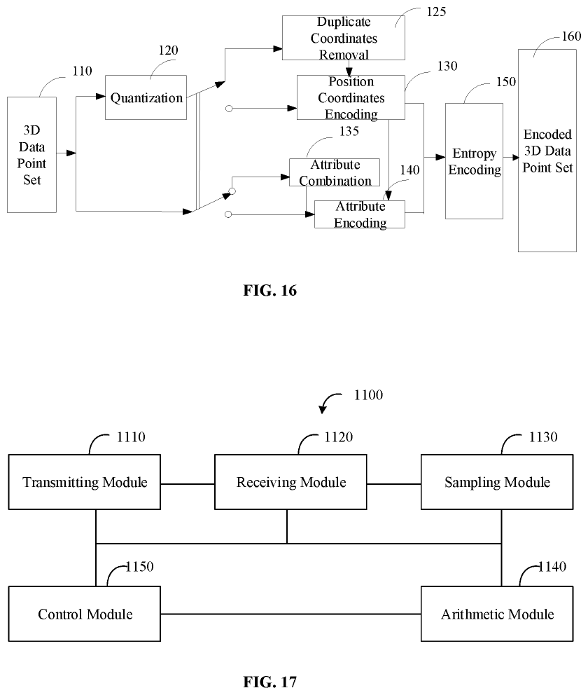

In some embodiments, after the encoder quantizes the position coordinates, the quantized position coordinates of at least two position coordinates may be the same, and these at least two position coordinates may correspond to at least two attribute values. At this time, before encoding the quantized position coordinates, the duplicate coordinates can be removed (e.g., the process at 125 as shown in FIG. 15 and FIG. 16). That is, the quantized position coordinates of the at least two position coordinates can be one (e.g., it can be referred to as the first position coordinates). Correspondingly, the at least two attribute values can be combined (e.g., the process at 135 shown in FIG. 15 and FIG. 16) to obtain one value, for example, the weighted combination can be performed. For the at least two position coordinates during decoding, the decoding end may decode a position coordinate and an attribute value.

Of course, in the embodiments of the present disclosure, even if the quantized position coordinates of at least two position coordinates are the same, it may not be needed to remove the duplicate coordinates and combine the at least two attribute values. At this time, a quantized position coordinates may correspond to at least two attribute value. When the decoding end performs decoding, at least two attribute values can be decoded for the quantized position coordinates, such that at least two 3D data points can be obtained.

In some embodiments, since different quantized position coordinates may correspond to different numbers of attribute values, the number of corresponding attribute values can be written in the bitstream for each quantized position coordinates. In this way, the decoder can determine the number of attributes corresponding to each position coordinates based on the information carried in the bitstream. In addition, the bitstream of the attribute may be continuous, each attributed may be decoded in sequence, and the corresponding position coordinates and attributes may be realized by corresponding to the order of the 3D data points.

Of course, in some embodiments, only the special quantized position coordinates (e.g., the number of corresponding attribute values may be more than one) may be marked

In some embodiments, whether the encoder removes duplicate coordinates and combines attributes can be preset on the encoder. For example, some encoders may be preset to remove duplicate coordinates and perform attribute combination, and some encoders may be preset to not remove duplicate coordinates and perform attribute combination.

Alternatively, whether the encoder removes duplicate coordinates and combines attributes can also be selected by the encoder. In some embodiments, the encoder may determine whether to remove duplicate coordinates and combine attributes based on the current encoding conditions. For example, as shown in FIG. 16, after quantization in the process at 120, the position coordinates can be directly encoded in the process at 130, and not to combine the attributes in the process at 135, but directly encode the attributes in the process at 140. Alternatively, after the quantization in the process at 120, the encoder may choose to remove the duplicate coordinates in the process at 125, encode the position coordinates in the process at 130, combine the attributes in the process at 135, and encode the attributes in the process at 140.

More specifically, if the current encoding loss is directed to be as low as possible or the compression rate is not high, then the duplicate coordinate removal and attribute combination may not be performed, otherwise, the duplicate coordinate removal and attribute combination may be performed.

Consistent with the present disclosure, the breadth-first approach can be used to encode or decode the Nth layer of the multi-tree. In addition, when all the point cloud points of one node of the Nth layer fall into the same node in the lower layer, the node can be encoded or decoded in a depth-first manner, thereby realizing flexible coding of nodes, and improving the coding performance.

In some embodiments, the 3D data point described above may be any point cloud point in the point cloud data obtained by a distance measuring device. In some embodiments, the distance measuring device may be an electronic device such as a lidar and a laser distance measuring device. In some embodiments, the distance measuring device can be used to sense external environmental information, such as distance information, orientation information, reflection intensity information, speed information, etc. of targets in the environment. A point cloud point may include at least one of the external environment information measured by the distance measuring device. In some embodiments, when the distance measuring device obtains a certain number of 3D data points, a data packet can be generated based on the certain number of 3D data points. The encoding/decoding method for 3D data point set provided in the embodiments of the present disclosure can be applied to encode/decode 3D data points in the data packet.

In some embodiments, the distance measuring device can detect the distance from a detection object to the distance measuring device by measuring the time of light propagation between the distance measuring device and the detection object, that is, the time-of-flight (TOF). Alternative, the distance measuring device can also detect the distance from the detection object to the distance measuring device through other methods, such as the distance measuring method based on phase shift measurement, or the distance measuring method based on frequency shift measurement, which is not limited in the embodiments of the present disclosure.

In some embodiments, the scanning trajectory of the distance measuring device may change over time. In this way, as the scanning time accumulates, the 3D data points scanned by the distance measuring device in the field of view may be distributed more and more densely in the field of view.

For ease of understanding, the working process of distance measurement will be described below in conjunction with a distance measuring device 1100 shown in FIG. 17.

As shown in FIG. 17, the distance measuring device 1100 includes a transmitting circuit 1110, a receiving circuit 1120, a sampling circuit 1130, and an arithmetic circuit 1140.

The transmitting circuit 1110 may emit a light pulse sequence (e.g., a laser pulse sequence). The receiving circuit 1120 can receive the light pulse sequence reflected by the object to be detected, and perform photoelectric conversion on the light pulse sequence to obtain an electrical signal, and then the electrical signal can be processed and output to the sampling circuit 1130. The sampling circuit 1130 can sample the electrical signal to obtain a sampling result. The arithmetic circuit 1140 can determine the distance between the distance measuring device 1100 and the object to be detected based on the sampling result of the sampling circuit 1130.

In some embodiments, the distance measuring device 1100 may further include a control circuit 1150. The control circuit 1150 can control other circuits, such as control the working time of each circuit and/or set parameters for each circuit, etc.

It should be understood that although the distance measuring device shown in FIG. 17 includes a transmitting circuit, a receiving circuit, a sampling circuit, and an arithmetic circuit to emit a light beam for detection, however, the embodiments of the present disclosure are not limited thereto. The number of any one of the transmitting circuit, the receiving circuit, the sampling circuit, and the arithmetic circuit may also be at least two, which can be used to emit at least two light beams in the same direction or different directions. In some embodiments, the at least two light beams may be emitted at the same time or at different times. In one example, the light emitting chips in the at least two emitting circuits may be packaged in the same module. For example, each transmitting circuit may include a laser transmitting chip, and the dies in the laser transmitting chips in the at least two transmitting circuits may be packaged together and housed in the same packaging space.

In some implementations, in addition to the circuit shown in FIG. 17, the distance measuring device 1100 may further include a scanning module 1160, which can be used to change the propagation direction of at least one laser pulse sequence emitted by the transmitting circuit and emit it.

In some embodiments, a module including the transmitting circuit 1110, the receiving circuit 1120, the sampling circuit 1130, and the arithmetic circuit 1140, or a module including the transmitting circuit 1110, receiving circuit 1120, sampling circuit 1130, arithmetic circuit 1140, and control circuit 1150 may be referred to as a distance measuring module. The distance measuring module 1150 may be independent of other modules, such as the scanning module 1160.

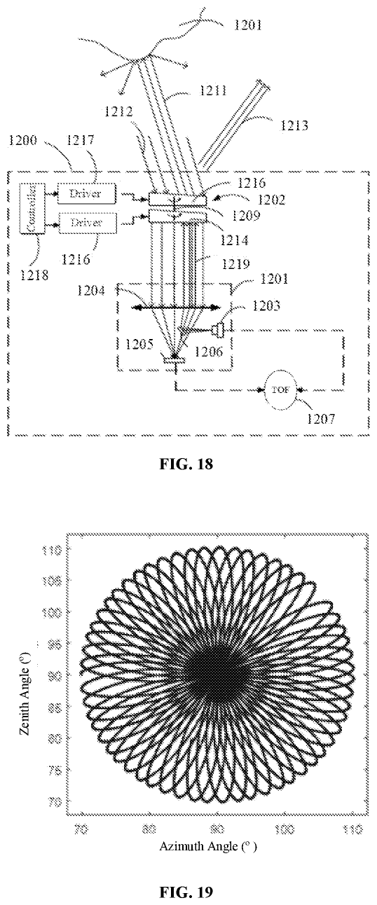

A coaxial light path may be used in the distance measuring device, that is, the light beam emitted by the distance measuring device and the reflected light beam can share at least a part of the light path in the distance measuring device. For example, after at least one laser pulse sequence emitted by the transmitting circuit changes its propagation direction through the scanning module and exits, the laser pulse sequence reflected by the object to be detected may pass through the scanning module and enter the receiving circuit. Alternatively, the distance measuring device may also adopt an off-axis light path, that is, the light beam emitted by the distance measuring device and the reflected light beam may be respectively transmitted along different light paths in the distance measuring device. FIG. 18 is a schematic diagram of a light detection device using a coaxial light path according to an embodiment of the present disclosure.

A distance measuring device 1200 includes a distance measuring module 1210. The distance measuring module 1210 includes a transmitter 1203 (including the transmitting circuit described above), a collimating element 1204, a detector 1205 (which may include the receiving circuit, sampling circuit, and arithmetic circuit described above), and a light path changing element 1206. The distance measuring module 1210 may be used to transmit the light beam, receive the returned light, and convert the returned light into an electrical signal. In some embodiments, the transmitter 1203 may be used to emit a light pulse sequence. In one embodiment, the transmitter 1203 may emit a sequence of laser pulses. In some embodiments, the laser beam emitted by the transmitter 1203 may be a narrow-bandwidth light beam with a wavelength outside the visible light range. The collimating element 1204 may be disposed on an exit light path of the transmitter and used to collimate the light beam emitted from the transmitter 1203 and collimate the light beam emitted from the transmitter 1203 into parallel light and output to the scanning module. The collimating element may also be used to condense at least a part of the returned light reflected by the object to be detected. The collimating element 304 may be a collimating lens or other elements capable of collimating light beams.

In the embodiment shown in FIG. 18, by using the light path changing element 1206 to combine the transmitting light path and the receiving light path in the distance measuring device before the collimating element 1204, the transmitting light path and the receiving light path can share the same collimating element, making the light path more compact. In some other implementations, the transmitter 1203 and the detector 1205 may also use their respective collimating elements, and the light path changing element 1206 may be disposed on the light path behind the collimating element.

In the embodiment shown in FIG. 18, since the beam aperture of the light beam emitted by the transmitter 1203 is relatively small, and the beam aperture of the returned light received by the distance measuring device is relatively large, the light path changing element may use a small-area mirror to combine the emitting light path and the receiving light path. In some other implementations, the light path changing element may also adopt a reflector with a through hole, where the through hole may be used to transmit the emitted light of the transmitter 1203, and the reflector may be used to reflect the returned light to the detector 1205. In this way, it is possible to reduce the blocking of the returned light by the support of the small reflector when the small reflector is used.

In the embodiment shown in FIG. 18, the light path changing element may deviate from the optical axis of the collimating element 1204. In some other implementations, the light path changing element may also be positioned on the optical axis of the collimating element 1204.

The distance measuring device 1200 may further include a scanning module 1202. The scanning module 1202 may be disposed on the exit light path of the distance measuring module 1210. The scanning module 1202 may be used to change the transmission direction of a collimated light beam 1219 emitted by the collimating element 1204, and project the returned light to the collimating element 1204. The returned light may be collected on the detector 1205 via the collimating element 1204.

In one embodiment, the scanning module 1202 may include at least one optical element for changing the propagation path of the light beam, where the optical element may change the propagation path of the light beam by reflecting, refracting, or diffracting the light beam. For example, the scanning module 1202 may include a lens, a mirror, a prism, a galvanometer, a grating, a liquid crystal, an optical phased array, or any combination of the foregoing optical elements. In one example, at least part of the optical element may be movable. For example, the at least part of the optical element may be driven by a driving module, and the movable optical element can reflect, refract, or diffract the light beam to different directions at different times. In some embodiments, a plurality of optical elements of the scanning module 1202 may rotate around a common axis 1209, and each rotating or vibrating optical element may be used to continuously change the propagation direction of the incident light beam. In one embodiment, the plurality of optical elements of the scanning module 1202 may rotate at different rotation speeds or vibrate at different speeds. In another embodiment, the plurality of optical elements of the scanning module 1202 may rotate at substantially the same rotation speed. In some embodiments, the plurality of optical elements of the scanning module 1202 may also rotate around different axes. In some embodiments, the plurality of optical elements of the scanning module 1202 may also rotate in the same direction or in different directions, or vibrate in the same direction or different directions, which is not limited herein.

In one embodiment, the scanning module 1202 may include a first optical element 1214 and a driver 1216 connected to the first optical element 1214. The driver 1216 may be used to drive the first optical element 1214 to rotate around the rotation axis 1209, such that the first optical element 1214 can change the direction of the collimated light beam 1219. The first optical element 1214 may project the collimated light beam 1219 to different directions. In one embodiment, an angle between the direction of the collimated light beam 1219 changed by the first optical element and the rotation axis 309 may change with the rotation of the first optical element 1214. In one embodiment, the first optical element 1214 may include a pair of opposite non-parallel surfaces, and the collimated light beam 1219 may pass through the pair of surfaces. In one embodiment, the first optical element 1214 may include a prism whose thickness may vary in at least one radial direction. In one embodiment, the first optical element 1214 may include a wedge-angle prism to collimate the beam 1219 for refracting.

In one embodiment, the scanning module 1202 may further include a second optical element 1215. The second optical element 1215 may rotate around the rotation axis 1209, and the rotation speed of the second optical element 1215 may be different from the rotation speed of the first optical element 1214. The second optical element 1215 may be used to change the direction of the light beam projected by the first optical element 1214. In one embodiment, the second optical element 1215 may be connected to another driver 1217, and the driver 1217 may drive the second optical element 1215 to rotate. The first optical element 1214 and the second optical element 1215 may be driven by the same or different drivers, such that the first optical element 1214 and the second optical element 1215 may have different rotation speeds and/or steering directions, such that the collimated light beam 1219 may be projected to different directions in the external space to scan a larger spatial range. In one embodiment, a controller 1218 may control the driver 1216 and driver 1217 to drive the first optical element 1214 and the second optical element 1215, respectively. The rotation speeds of the first optical element 1214 and the second optical element 1215 may be determined based on the area and pattern expected to be scanned in actual applications. The drivers 1216 and 1217 may include motors or other driving devices.

In some embodiments, the second optical element 1215 may include a pair of opposite non-parallel surfaces, and a light beam may pass through the pair of surfaces. In one embodiment, the second optical element 1215 may include a prism whose thickness may vary in at least one radial direction. In one embodiment, the second optical element 1215 may include a wedge-prism.

In one embodiment, the scanning module 1202 may further include a third optical element (not shown in the drawings) and a driver for driving the third optical element to move. In some embodiments, the third optical element may include a pair of opposite non-parallel surfaces, and a light beam may pass through the pair of surfaces. In one embodiment, the third optical element may include a prism whose thickness may vary in at least one radial direction. In one embodiment, the third optical element may include a wedge-prism. At least two of the first, second, and third optical elements may rotate at different rotation speeds and/or rotation directions.

The rotation of each optical element in the scanning module 1202 may project light to different directions, such as light directions 1211 and 1213, such that the space around the distance measuring device 1200 can be scanned. As shown in FIG. 19, which is a schematic diagram of a scanning pattern of the distance measuring device 1200. It can be understood that when the speed of the optical element in the scanning module changes, the scanning pattern will also change accordingly.

When the light 1211 projected by the scanning module 1202 hits an object to be detected 1201, a part of the light may be reflected by the object to be detected 1201 to the distance measuring device 1200 in a direction opposite to the projected light 1211. The returned light 1212 reflected by the object to be detected 1201 may incident on the collimating element 1204 after passing through the scanning module 1202.

The detector 1205 and the transmitter 1203 may be placed on the same side of the collimating element 1204, and the detector 1205 may be used to convert at least part of the returned light passing through the collimating element 1204 into electrical signals.

In some embodiments, each optical element may be coated with an anti-reflection coating. In some embodiments, the thickness of the anti-reflection coating may be equal to or close to the wavelength of the light beam emitted by the transmitter 1203, which can increase the intensity of the transmitted light beam.

In one embodiment, a filtering layer may be plated on the surface of an element positioned on the light beam propagation path in the distance measuring device, or a filter may be disposed on the light beam propagation path for transmitting at least the wavelength band of the light beam emitted by the transmitter, and reflect other wavelength bands to reduce the noise caused by ambient light to the receiver.

In some embodiments, the transmitter 1203 may include a laser diode, and nanosecond laser pulses may be emitted through the laser diode. Further, the laser pulse receiving time may be determined, for example, by detecting the rising edge time and/or falling edge time of the electrical signal pulse to determine the laser pulse receiving time. In this way, the distance measuring device 1200 may calculate the TOF using the pulse receiving time information and the laser pulse sending time information, thereby determining the distance from the object to be detected 1201 to the distance measuring device 1200.

The distance and orientation detected by the distance measuring device 1200 may be used for remote sensing, obstacle avoidance, surveying and mapping, navigation, and the like. In one embodiment, the distance measuring device provided in the embodiments of the present disclosure can be applied to a movable platform, and the distance measuring device can be mounted on the platform body of the movable platform. The movable platform including the distance measuring device can measure the external environment, such as measuring the distance between the movable platform and obstacles for obstacle avoidance and other purposes, and for two-dimensional or three-dimensional mapping of the external environment. In some embodiments, the movable platform may include at least one of an unmanned aerial vehicle (UAV), a vehicle, a remote-controlled vehicle, a robot, and a camera. When the distance measuring device is applied to a UAV, the platform body may be the body of the UAV. When the distance measuring device is applied to a vehicle, the platform body may be the body of the vehicle. The vehicle may be a self-driving vehicle or a semi-self-driving vehicle, which is not limited here. When the distance measuring device is applied to a remote-controlled vehicle, the platform body may be the body of the remote-controlled vehicle. When the distance measuring device is applied to a robot, the platform body may be the robot. When the distance measuring device is applied to a camera, the platform body may be the camera itself.

FIG. 20 is a block diagram of a device 400 for processing a 3D data point set according to an embodiment of the present disclosure. The 3D data point set can be divided by a multi-tree method. The device 400 includes a first encoding or decoding unit 410 configured to encode or decode the Nth layer of the multi-tree using a breadth-first approach, and a second encoding or decoding unit 420 configured to use the depth-first approach to encode or decode a first node when all 3D data points in the first node of the Nth layer fall within the same node of the Mth layer under the first node, where N may be an integer greater than or equal to zero, and M may be an integer greater than or equal to one.

In some embodiments, the value of the bit corresponding to the 3D data point of the first node in the Kth layer may include the index value of the node to which the 3D data point of the first node belongs in the Kth layer. In some embodiments, the Kth layer may be one of the layers under the first node, and in the Kth layer, all 3D data points in the first node may fall into the same node.

In some embodiments, the index value of each node in the Kth layer may be preset, or the starting index values of the multiple index values corresponding to multiple nodes in the Kth layer may be determined based on the node to which at least one 3D data point belongs in the upper layer of the Kth layer.

In some embodiments, the index value of each node in the Kth layer may be preset based on the position of each node. The index value of the node at the corresponding position in the Kth layer where the position of the node of the previous layer is located may be the starting index value.

In some embodiments, the second encoding or decoding unit 420 may be configured to use the breadth-first approach to encode or decode the sub-nodes of the first node in a Qth layer when all the 3D data points of the first node fall into multiple sub-nodes of the first node in the Qth layer, where Q may be an integer greater than or equal to one, and the Qth layer may be a layer below the Mth layer.

In some embodiments, the device may be used on the encoding end, and the second encoding or decoding unit 420 may be further configured to set the first identifier before the bit corresponding to the Qth layer, the first identifier being used to indicate that the breadth-first approach is used in the Qth layer to encode or decode the sub-nodes of the first node.

In some embodiments, the device may be used on the decoding end, and the second encoding or decoding unit 420 may be further configured to use the breadth-first approach to decode the sub-nodes of the first node at the Qth layer when the first identifier is obtained before the bit corresponding to the Qth layer. The first identifier can be used to indicate that the breadth-first approach is used in the Qth layer to encode or decode the sub-nodes of the first node.

In some embodiments, in the Qth layer below the Nth layer, the first identifier may be set before the bit corresponding to the Qth layer when the breadth-first approach is used on the first layer to encodes or decodes the sub-nodes of the first node.

In some embodiments, the first identifier may include a prefix and a suffix, and the index value of a node may include a prefix and a suffix. The bit value of the prefix of the first identifier may be equal to the bit value of the prefix of the index value of the node. The number of bits in the suffix of the first identifier may be equal to the number of bits in the suffix of the index value of the node, and the bit value of the suffix of the first identifier may not be equal to the bit value of the suffix of the index value of the node. The number of bits of the prefix of the index value of the node may be equal to the number of bits of the index value of other nodes, and the bit value of the prefix of the index value of the node may be different from the index values of other nodes.

In some embodiments, the device may be used on the encoding end, and the second encoding or decoding unit 420 may be further configured to set a second identifier before the bit describing the sub-node division of the first node. The second identifier may indicate a switch from the breadth-first approach to the depth-first approach to encode or decode the first node.

In some embodiments, the device may be used on the decoding end, and the second encoding or decoding unit 420 may be further configured to use the depth-first approach to decode the first node when the second identifier is obtained before the bit describing the sub-node division of the first node. The second identifier may indicate a switch from the breadth-first approach to the depth-first approach to encode or decode the first node.

In some embodiments, the second identifier may be obtained before the bit describing the sub-node division of the first node to indicate that all 3D data points in the first node fall into the same node of the Mth layer under the first node.

In some embodiments, the second identifier may be a plurality of zeros or ones, and the number of zeros or ones may be equal to the number of nodes in the Nth layer.

In some embodiments, the first encoding or decoding unit 410 may be further configured to use the breadth-first approach to encode or decode the sub-nodes of the second node in the layers below the Nth layer. In some embodiments, the second node may include any node other than the first node in the nodes of the Nth layer.

In some embodiments, the first encoding or decoding unit 410 may be further configured to skip the sub-nodes of the first node when using the breadth-first approach to encode or decode the sub-nodes of the second node.

In some embodiments, when there are multiple first nodes in the Nth layer, the encoding processing of any one of the first nodes and its sub-nodes may be parallel to the encoding or decoding processing of the other first nodes and their sub-nodes.

In some embodiments, the encoding or decoding processing of the first node and its sub-nodes may be performed parallel to the encoding or decoding processing of nodes other than the first node and their sub-nodes in the Nth layer.

In some embodiments, the octree encoding or decoding may be the position coordinates of the 3D data point set.

In some embodiments, the device 400 further includes a third encoding or decoding unit 430. The third encoding or decoding unit 430 may be configured to encode or decode the attributes of the 3D data points in the 3D data point set using a binary encoding or decoding method, or a hierarchical encoding method.

In some embodiments, the multi-tree may be an octree.

It should be understood that the device 400 can be used to implement the corresponding operations implemented by the decoding end in the foregoing method. For brevity, details will not be repeated here.

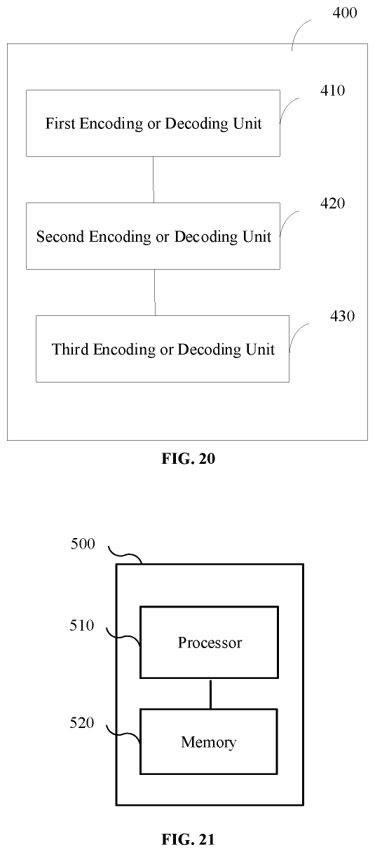

FIG. 21 is a block diagram of a computer system 500 according to an embodiment of the present disclosure. As shown in FIG. 21, the computer system 500 includes a processor 510 and a memory 520.

It should be understood that the computer system 500 may also include components commonly included in other computer systems, such as input and output devices, communication interfaces, etc., which is not limited in the embodiments of the present disclosure.

The memory 520 is configured to store computer-executable instructions.

The memory 520 may be various types of memory, for example, it may include a high-speed random-access memory (RAM), and may also include a non-volatile memory such as at least one disk memory, which is not limited by the embodiments of the present disclosure.

The processor 510 is configured to access the memory 520 and execute the computer-executable instructions to perform operations in the method for processing a 3D data point set according to various embodiments of the present disclosure.

The processor 510 may include a microprocessor, a field-programmable gate array (FPGA), a central processing unit (CPU), a graphics processing unit (GPU), etc., which is not limited by the embodiments of the present disclosure.

The device and computer system for process a 3D data point set described in the embodiments of the present disclosure may correspond to the execution body of the method for processing a 3D data point set described in the embodiments of the present disclosure, and can be used for the above-mentioned and other operations and/or functions of each module in the device and computer system for processing the 3D data point set, respectively, in order to realize the corresponding procedures of the aforementioned various methods. For brevity, details will not be repeated here.

An embodiment of the present disclosure further provides an electronic device. The electronic device may include the device or computer system for processing a 3D data point set of the various embodiments of the present disclosure described above.

An embodiment of the present disclosure further provides a computer storage medium. The computer storage medium stores program code, and the program code may be configured to perform the method for processing the 3D data point set described in foregoing embodiments of the present disclosure.

It should be understood that, in the embodiments of the present disclosure, the term “and/or” is merely a relationship describing a related object, indicating that there may be three relationships. For example, A and/or B indicates three cases, A alone, A and B, and B alone. In addition, the character “/” in this text generally indicates that the related objects are in an alternative (“or”) relationship.

Those of ordinary skill in the art may realize that the units and algorithm steps of each example described in connection with the embodiments disclosed herein can be implemented by electronic hardware, computer software, or a combination of the two. In order to clearly illustrate the interchangeability between hardware and software, the composition and steps of each example have been described generally in terms of functions in the above description. Whether these functions are performed in hardware or software depends on the specific application and design constraints of the technical solution. A person skilled in the art can use different methods to implement the described functions for each specific application, but such implementation should not be considered to be beyond the scope of the present disclosure.

Those skilled in the art can clearly understand that, for the convenience and brevity of description, the specific operating processes of the system, apparatus, and units described above can be referred to the corresponding processes in the foregoing method embodiments, and are not described herein again.

In the several embodiments provided in this application, it should be understood that the disclosed system, apparatus, and method may be implemented in other ways. For example, the apparatus embodiments described above are only schematic. For example, the division of the unit is only a logical function division. In actual implementation, there may be another division manner. For example, multiple units or components may be combined or can be integrated into another system, or some features can be ignored or not implemented. In addition, the displayed or discussed mutual coupling or direct coupling or connection may be indirect coupling or connection through some interfaces, devices, or units, or may be electrical, mechanical, or other forms of connection.

The units described as separate components may or may not be physically separated. The components displayed as units may or may not be physical units, may be located in one place, or may be distributed to multiple network units. Some or all of the units may be selected according to actual needs to achieve the objectives of the solutions of the embodiments of the present disclosure.

In addition, each functional unit in each embodiment of the present disclosure may be integrated into one processing unit, or each unit may exist separately physically, or two or more units may be integrated into one unit. The above integrated unit may be implemented in the form of hardware or in the form of software functional unit.

When the integrated unit is implemented in the form of a software functional unit and sold or used as an independent product, it may be stored in a computer-readable storage medium. Based on this understanding, the technical solution of the present disclosure is essentially a part that contributes to the existing technology, or all or part of the technical solution may be embodied in the form of a software product, which is stored in a storage medium, including some instructions for causing a computer device (which may be a personal computer, a server, or a network device, etc.) to perform all or part of the steps of the method described in the embodiments of the present disclosure. The foregoing storage medium includes flash drive, mobile hard disks, read-only memory (ROM), random-access memory (RAM), magnetic disks, or optical disks and other medium that can store program codes.

The above description is only specific embodiments of the present disclosure, but the protected scope of the present disclosure is not limited to this. Any person skilled in the art can easily think of various kinds of equivalent modifications or substitutions within the technical scope disclosed by the present disclosure. The modifications or substitutions should be covered by the protected scope of the present disclosure. Therefore, the protected scope of the present disclosure shall be in conformity with the protected scope of the appended claims.

What is claimed is:

1. A three-dimensional (3D) data point set processing method, the 3D data point set being divided by a multi-tree method, the 3D data point set processing method comprising:
encoding or decoding a Nth layer of the multi-tree in by using a breadth-first approach; and
encoding or decoding a first node by using a depth-first approach when all 3D data points in the first node of the Nth layer fall into a same node of a Mth layer under the first node, wherein N and M are integers greater than or equal to one.

2. The method of claim 1, wherein:
a bit value corresponding to the 3D data point of the first node in a Kth layer includes an index value of the node to which the 3D data point of the first node belongs in the Kth layer, the Kth layer being one of the layers under the first node, and all 3D data points in the first node fall into the same node in the Kth layer.

3. The method of claim 2, wherein:
the index value of each node in the Kth layer is preset; or,
a plurality of starting index values of a plurality of index values corresponding to a plurality of nodes in the Kth layer are determined based on a node to which at least one 3D data point belongs in an upper layer of the Kth layer.

4. The method of claim 3, wherein:
the index value of each node in the Kth layer is preset based on a position of each node; and
the index value of the node at the corresponding position in the Kth layer where the position of the node of the previous layer is located is the starting index value.

5. The method of claim 1, wherein encoding or decoding the first node by using the depth-first approach includes:
using the breadth-first approach to encode or decode a plurality of sub-nodes of the first node in a Qth layer when all 3D data points of the first node fall into sub-nodes of the first node in the Qth layer, Q being an integer greater than or equal to one, and the Qth layer being a layer below the Mth layer.

6. The method of claim 5, further comprising:
on an encoding end, setting a first identifier before a bit corresponding to the Qth layer, the first identifier indicating that the breadth-first approach is used in the Qth layer to encode or decode the sub-nodes of the first node.

7. The method of claim 5, wherein using the breadth-first approach to encode or decode the sub-nodes of the first node in the Qth layer includes:
on a decoding end, using the breadth-first approach to decode the sub-nodes of the first node in the Qth layer when the first identifier is obtained before the bit corresponding to the Qth layer, the first identifier indicating the breadth-first approach is used in the Qth layer to encode or decode the sub-nodes of the first node.

8. The method of claim 6, wherein:
the first identifier is set before the bit corresponding to the Qth layer when the Qth layer is below the Nth layer and a first layer that encodes or decodes the sub-nodes of the first node uses the breadth-first approach.

9. The method of claim 6, wherein:
the first identifier includes a prefix and a suffix, and the index value of one node includes the prefix and the suffix;
the bit value of the prefix of the first identifier is equal to the bit value of the prefix of the index value of the one node;
a number of bits in the suffix of the first identifier is equal to the number of bits in the suffix of the index value of the one node, and the bit value of the suffix of the first identifier is different from the bit value of the suffix of the index value of the one node; and
the number of bits of the prefix of the index value of the one node is equal to the number of bits of the index value of other nodes, and the bit value of the prefix of the index value of the one node is different from the index values of other nodes.

10. The method of claim 1, further comprising:
on the encoding end, setting a second identifier before a bit describing a sub-node division of the first node, the second identifier indicating a switch from the breadth-first approach to the depth-first approach to encode or decode the first node.

11. The method of claim 1, wherein encoding or decoding the first node by using the depth-first approach includes:
on the decoding end, using the depth-first approach to decode the first node in response to obtaining the second identifier before the bit describing the sub-node division of the first node, the second identifier indicating a switch from the breadth-first approach to the depth-first approach to encode or decode the first node.

12. The method of claim 11, wherein:
the second identifier is obtained before the bit describing the sub-node division of the first node to indicate that all 3D data points in the first node fall into the same node of the Mth layer under the first node.

13. The method of claim 10, wherein:
the second identifier is a plurality of zeros or ones, and a number of zeros or ones is equal to a number of nodes in the Nth layer.

14. The method of claim 1, further comprising:
using the breadth-first approach to encode or decode the sub-nodes of a second node, the second node including any node other than the first node in a plurality of nodes of the Nth layer.

15. The method of claim 14, further comprising:
skipping the sub-nodes of the first node when using the breadth-first approach to encode or decode the sub-nodes of the second node.

16. The method of claim 1, wherein:
when there is a plurality of first nodes in the Nth layer, the encoding of any one of the first nodes and its sub-nodes is parallel to the encoding or decoding of other first nodes and their sub-nodes.

17. The method of claim 1, wherein:
the encoding or decoding of the first node and its sub-nodes is parallel to the encoding or decoding of nodes other than the first node and their sub-nodes in the Nth layer.

18. The method of claim 1, wherein:
the multi-tree is an octree.

19. The method of claim 1, wherein:
the bit value of the 3D data point of the first node corresponding to the Kth layer includes an index value, the index value being preset fixed value.

20. The method of claim 19, wherein:
the index value is fixed at 111.

21. A device for processing a 3D data point set, the 3D data point set being divided in a multi-tree method, and the device comprising:
a first encoding or decoding unit configured to encode or decode a Nth layer of the multi-tree by using a breadth-first approach; and
a second encoding or decoding unit configured to encode or decode a first node by using a depth-first approach when all 3D data points in the first node of the Nth layer fall into a same node of a Mth layer under the first node, wherein N and M are integers greater than or equal to one.
